(19) United States
(12) Patent Application Publication
(10) Pub. No.: US 2023/0347268 A1
(43) Pub. Date: Nov. 2, 2023

(54) VACUUM-CLEANER FILTER BAG MADE FROM RECYCLED PLASTICS

(71) Applicant: EUROFILTERS N.V., Overpelt (BE)

(72) Inventors: Ralf Sauer, Overpelt (BE); Jan Schultink, Overpelt (BE)

(21) Appl. No.: 18/006,051

(22) PCT Filed: Aug. 2, 2021
(86) PCT No.: PCT/EP2021/071555

§ 371 Date: Jan. 19, 2023

(30) Foreign Application Priority Data
Aug. 6, 2020 (EP) 20189873.1

(51) Int. Cl. B01D 39/16

(52) U.S. Cl. CPC B01D 39/1623; B01D 2239/0216; B01D 2239/0283; B01D 2239/0435; B01D 2239/0618; B01D 2239/0622; B01D 2239/0654; B01D 2239/1291

(57) ABSTRACT

The invention relates to a vacuum cleaner filter bag comprising a wall which is made of an air-permeable material and surrounds an inner space, and an inlet opening introduced into the wall, wherein the air-permeable material comprises at least one layer made of a non-woven and/or a layer made of a fiber web, said non-woven and/or a fiber web comprising fibers or consisting thereof, which are made from a recycled plastic or a plurality of recycled plastics, wherein the recycled plastic or the plurality of recycled plastics comprise or are chemically recycled polypropylene.

The present invention relates to a vacuum cleaner filter bag formed primarily from recycled plastics.

Filter bags made of non-woven materials have virtually completely replaced paper filter bags in the last 10 years due to their considerably better usage properties. In particular, the separation efficiency, the tendency to clogging and the mechanical strength have been continuously improved. The non-wovens used for this purpose are generally made of thermoplastics, in particular polypropylene (PP) and/or polyester (PET).

Even though there is still a need for further improvement of these properties, it is nevertheless already noticeable that the high costs for the complex filter constructions are finding less and less acceptance among end customers.

In addition, the use of high-quality and heavy non-wovens for a disposable product is increasingly being viewed critically for ecological reasons.

Biodegradable filter bags as proposed in EP 2 301 404 and WO 2011/047764 also do not seem to be a promising approach to improve ecological properties, since filter bags are often disposed of via waste incineration and composting is out of the question simply because of the primarily non-biodegradable absorbent material.

Today, non-woven filter bags for vacuum cleaners always consist of several layers (EP 1 198 280, EP 2 433 695, EP 1 254 693). Use is made of supporting layers to achieve the necessary mechanical strength, coarse filter layers that have a high storage capacity for dust without increasing air resistance too much, and fine filter layers for filtration of particles < 1 µm.

To increase the dust storage capacity, diffusers and partitions have also been used in filter bags for some years, which are intended to optimize the flow conditions in the filter bag in order to increase the service life.

A wide variety of technologies are used to manufacture these different materials. Meltblown microfiber non-wovens are usually used as the fine filter layer. These meltblown non-wovens are extrusion non-wovens usually made of polypropylene and have filament diameters ranging from less than 1 µm to a few µm. To achieve high separation efficiencies, these materials are electrostatically charged (e.g. by corona discharge). To further improve the separation efficiency, it has been proposed to apply nanofibers produced by the electrospinning process to non-woven substrate materials (DE 199 19 809).

For the capacity layer, staple fiber non-wovens, extrusion non-wovens, but also fiber webs (EP 1 795 247) made of staple fibers or filaments are used. Mostly polypropylene or polyester, but also fluff pulp (EP 0 960 645, EP 1 198 280) are used as materials for capacity layers.

The use of recycled plastics (e.g. recycled polyethylene terephthalate (rPET)) for fabrics was proposed in WO 2013/106392.

The use of rPET as a raw material for meltblown non-wovens has already been investigated (Handbook of Non-wovens, Woodhead Publishing Ltd., Ed. by S.J. Russelt, Chapter 4.10.1).

CN101747596 describes the use of recycled PET or recycled PBT (rPET/rPBT) as material for microfilaments.

Based on this, it is thus the object of the present invention to specify vacuum cleaner filter bags that are in no way inferior to the vacuum cleaner filter bags on the market in terms of dust collection performance and service life, and thus have excellent usage properties, but are predominantly made from recycled materials or from waste materials. In particular, therefore, it is the object of the present invention to realize particularly advantageous vacuum cleaner filter bags, both ecologically and economically. Preferably, a proportion of recycled materials in the filter bag of 40% up to 95% is to be realized. Such a filter bag would thus meet the Global Recycled Standard (GRS), v3.

This object is solved with the vacuum cleaner filter bag according to patent claim 1. The dependent patent claims represent advantageous embodiments in this regard. Patent claim 14 further discloses the applicability of recycled plastics for vacuum cleaner filter bags.

The invention thus relates to a vacuum cleaner filter bag including a wall of an air-permeable material enclosing an interior space. An inlet opening is provided in the wall, via which, for example, a vacuum cleaner nozzle may be introduced into the vacuum cleaner filter bag. In this regard, the air-permeable material of the wall includes at least a layer of a non-woven and/or a layer of a fiber web, wherein the non-woven and/or the fiber web include or consist of fibers formed from one or more recycled plastics.

The term “recycled plastic” used for the purposes of the present invention is to be understood synonymously with plastic recyclates. For the conceptual definition, reference is made here to the standard DIN EN 15347:2007.

The vacuum cleaner filter bag according to the present invention includes a wall made of an air-permeable material, which may, for example, have a multilayer structure. At least one of these layers is thereby a non-woven material or a fiber web material including recycled plastics and, in particular, formed from recycled plastics. In contrast to the vacuum cleaner filter bags known from the prior art, thus less or no fresh/pure (virgin) plastic material is used for the production of the non-wovens or fiber webs underlying the wall of the vacuum cleaner filter bag, but predominantly or exclusively plastics are used that have already been in use and have been recovered by appropriate recycling processes. Such filter bags are clearly advantageous from an ecological point of view, since they may be manufactured with a high degree of raw material neutrality. These filter bags likewise offer economic advantages, since most recycled plastic materials may be obtained at significantly lower cost than the corresponding raw materials that are not recycled (“virgin” plastics).

For the purposes of the present invention, a non-woven or non-woven web in this context refers to a tangled web that has undergone a bonding step so that it has sufficient strength to be wound or unwound into rolls, for example, by machine (i.e., on an industrial scale). The minimum web tension required for rewinding is 0.25 PLI or 0.044 N/mm. The web tension should not be higher than 10% to 25% of the minimum maximum tensile force (according to DIN EN 29073-3:1992-08) of the material to be wound. This results in a minimum value of the maximum tensile force for a material to be wound of 8.8 N per 5 cm strip width.

A fiber web corresponds to a tangled web, which, however, has not undergone a bonding step, so that, in contrast to a non-woven, such a tangled web does not have sufficient strength to be wound or unwound into rolls by machine, for example. With regard to the definition of this terminology, reference is made to EP 1 795 427 A1, the disclosure content of which in this respect is also made the subject matter of the present patent application.

In this context, the one recycled plastic or the plurality of recycled plastics form the starting material, from which the fibers are spun, in particular melt-spun. Thus, the fibers are formed by spinning from the one or more recycled plastics.

According to a preferred embodiment, the fibers of the non-woven or fiber web included in the air-permeable material of the wall of the vacuum cleaner filter bag according to the invention are formed from a single recycled plastic material.

Alternatively, however, it is equally preferred if the fibers of the non-woven or the fiber web are formed from different materials, at least one of which is a recycled plastic material. Thus, the fibers may also be spun to some extent from a virgin plastic. In this case in particular two embodiments are conceivable:

On the one hand, it may be a mixture of at least two types of fibers, for example fiber mixtures formed from at least two different recycled plastics.

On the other hand, it is also possible that the fiber web or the non-woven contains or is formed from bi-component fibers (bi-co fibers), which consist of a core and a sheath enveloping the core. Core and sheath are made of different materials. In addition to core/sheath bi-component fibers, the other common variants of bi-component fibers (e.g. side by side) are also possible.

The bi-component fibers may be in the form of staple fibers or formed as an extrusion non-woven (for example, from meltblown non-woven), so that the bi-component fibers theoretically have infinite length and represent so-called filaments. In the case of such bi-component fibers, it is advantageous if at least the core is formed from a recycled plastic; for the sheath, for example, a virgin plastic may also be used, but alternatively another recycled plastic may also be used.

For the non-wovens or fiber webs for the purposes of the present invention, it is possible that they are dry-laid, wet-laid or extrusion non-wovens or webs. Accordingly, the fibers of the non-wovens or fiber webs may be of finite length (staple fibers), but may also be theoretically of infinite length (filaments).

Furthermore, it is possible that the air-permeable materials of the wall of the vacuum cleaner filter bag include at least one layer of a non-woven including dusty and/or fibrous recycled material from the manufacture of textiles, in particular cotton textiles, and/or from wool shearing and/or seed fibers. The dusty and/or fibrous recycled material may be cotton dust in particular. The seed fibers may be cotton linters or kapok fibers.

Such a non-woven is thereby bonded by means of bonding fibers, for example “fusion fibers” or bi-component fibers, so that the dusty and/or fibrous recycled material or the seed fibers are present in bonded form. The fusion fibers or bi-component fibers thereby preferably include at least one recycled plastic. Corresponding non-woven materials are known, for example, from WO 2011/057641 A1. Also, the non-woven materials according to the invention may be designed accordingly.

For example, the air-permeable material may include at least one layer of a non-woven including dusty and/or fibrous recycled material from the manufacture of textiles, in particular cotton textiles, and/or from wool shearing and/or seed fibers.

The dusty and/or fibrous recycled material from the manufacture of textiles is produced in particular during the processing of textile materials (in particular textile fibers and filaments, as well as linear, planar and spatial textile structures produced therewith), such as the manufacture (including carding, spinning, cutting and drying) or recycling of textile materials. These dusty and/or fibrous materials represent waste materials that may settle on the machinery or filter materials used to process the textiles. The dust and/or fibers are normally disposed of and thermally recycled.

The dusty and/or fibrous recycled material is therefore, for example, production waste; this applies in particular to material that is a waste product during the carding, spinning, cutting or drying of textile materials. In this case, it is also referred to as “pre-consumer waste”.

The recycling of textile materials, i.e. the processing (e.g. shredding) of used textile materials or textiles (e.g. old clothes) also produces dusty and/or fibrous recycled material; this is referred to as “post-consumer waste”.

Thus, the dusty and/or fibrous recycled material from the manufacture of textiles includes, in particular, fibers obtained from waste materials from the textile and clothing industry, from post-consumer waste (textiles and the like) and from products collected for recycling.

Shearing sheep to obtain wool produces short wool fibers as a waste product, which are another variant of a dusty and/or fibrous recycled material in the form according to the invention.

Cotton linters are short cotton fibers that adhere to the cotton seed core after the long seed hair (cotton) has been removed from the core. Cotton linters vary widely in fiber length (typically 1 to 6 mm) and purity, are not spinnable, and are typically a non-recyclable residual material in the textile industry and thus a waste product. A distinction may be made between first cut (FC linters), second cut (SC linters) and mill run. Linters may be cleaned and bleached to obtain Cotton Linters Cellulose (CLC). Cotton linters may also be used for the non-wovens that may be used in air-permeable materials for the vacuum cleaner filter bags according to the invention. In particular, uncleaned and unbleached FC and/or SC linters may be used.

The dusty and/or fibrous recycled material may be further comminuted before use (e.g., by known grinding methods (hammer mill, impact mill) or cutting methods) to adjust the desired fiber length distribution.

In the non-woven layer contained in the air-permeable material, the dusty and/or fibrous recycled material or seed fibers are bound. In this respect, the non-woven material has undergone a bonding step. The bonding of the dusty and/or fibrous recycled material and/or the seed fibers is preferably achieved by adding bonding fibers to the non-woven layer, which may, for example, be thermally activated (thermofusion).

The production of a corresponding non-woven layer may thus be carried out by, for example, depositing the dusty and/or fibrous recycled material and/or the seed fibers together with the bonding fibers in an aerodynamic process and then bonding to the finished non-woven by thermal activation of the bonding fibers.

Aerodynamic processes represent drying processes as explained and defined in section 4.1.3 of the handbook “Non-wovens” by H. Fuchs and W. Albrecht, Wiley-VCH, 2nd edition 2012. This section is incorporated herein by reference. The deposition of the dusty and/or fibrous recycled material and/or seed fibers together with the bonding fibers may be performed, in particular, by means of the airlay or the airlaid process. The airlay web formation may be carried out, for example, by means of a Rando weaver.

In a preferred embodiment, it is provided that the at least one layer of the non-woven including dusty and/or fibrous recycled material and/or seed fibers includes or consists of up to 95% by weight, preferably 70 to 90% by weight, of the dusty and/or fibrous recycled material and/or seed fibers and at least 5% by weight, preferably 10 to 50% by weight, of bonding fibers, in particular bi-component fibers.

The bonding fibers may, for example, be so-called “fusing fibers” formed from thermoplastic, fusible materials. These fusing fibers melt during thermal activation and bond the dusty and/or fibrous recycled material or the seed fibers.

The fusing fibers or bi-component fibers preferably used as bonding fibers may thereby consist partially or entirely of recycled plastics. The bonding fibers may be crimped (“crimped”) or smooth (uncrimped). The crimped bonding fibers may be mechanically crimped or self-crimping (e.g. in the form of bi-component fibers with an eccentric cross-section).

Particularly advantageous are bi-component fibers whose core consists of recycled polyethylene terephthalate (rPET) or recycled polypropylene (rPP), with the sheath consisting of polypropylene, which may be “virgin” or likewise a recycled material.

In a preferred embodiment, the bonding fibers are staple fibers, in particular with a length of 1 to 100 mm, preferably 2 to 40 mm. The fiber length may be determined according to DIN 53808-1:2003-01.

In principle, the recycled plastic may be selected from the group consisting of recycled polyesters, in particular recycled polyethylene terephthalate (rPET), recycled polybutylene terephthalate (rPBT), recycled polylactic acid (rPLA), recycled polyglycolide and/or recycled polycaprolactone; recycled polyolefins, particularly recycled polypropylene (rPP), recycled polyethylene and/or recycled polystyrene (rPS); recycled polyvinyl chloride (rPVC), recycled polyamides, and mixtures and combinations thereof.

Relevant international standards exist for many recycled plastics. For PET plastic recyclates, for example, DIN EN 15353:2007 is relevant. PS recyclates are described in more detail in DIN EN 15342:2008. PE recyclates are dealt with in DIN EN 15344:2008. PP recyclates are characterized in DIN EN 15345:2008. PVC recyclates are described in more detail in DIN EN 15346:2015. For the purpose of the corresponding special plastic recyclates, the present patent application adopts the definitions of these international standards. In this context, the plastic recyclates may be non-metallized. An example would be plastic flakes or chips recovered from PET beverage bottles. Likewise, the plastic recyclates may be metallized, for example, if the recyclates were obtained from metallic plastic films, especially metallized PET films (MPET).

The recycled plastic may be recycled polyethylene terephthalate (rPET) obtained, for example, from beverage bottles, in particular from so-called bottle flakes, i.e. pieces of ground beverage bottles.

Preferably, the recycled plastic is recycled polypropylene (rPP). In principle, the rPP may be either a physically or a chemically recycled rPP material. Physically recycled rPP materials are obtained, for example, by physically separating PP material from waste, such as household waste.

In particular, however, it is preferred that the rPP material is a chemically recycled material. In this regard, in embodiments, the rPP is produced by depolymerizing “virgin” PP in propane, dehydrogenating propane in propene, and then polymerizing the propene so produced. Chemically recycled rPP material has the advantage over physically produced rPP material in that the chemical and mechanical properties may be selectively adjusted, as with “virgin” PP. In particular, chemically recycled rPP material may achieve properties comparable to those of “virgin” PP. Also, in contrast to physically recycled rPP, material impurities may be avoided.

Processes for producing chemically recycled rPP are generally implemented on a large scale and are known in the prior art. In the depolymerization process, in embodiments, “virgin” PP from plastic waste (such as packaging materials) or waste oil is thermally and/or chemically processed and converted to propane. In particular, propane produced by depolymerization may be produced via Neste’s NEXBTL™ technology. In the subsequent dehydrogenation process, the obtained propane is catalytically dehydrogenated and converted to propene. For example, in embodiments, dehydrogenation may be carried out using the Oleflex process from UOP. In this process, a propane-containing gas is preheated to 600-700° C. and dehydrogenated in a fluidized bed dehydrogenation reactor on a platinum catalyst supported by alumina. In the polymerization step, the propene is polymerized to polypropylene, i.e. rPP. Conventional catalytic processes, such as Ziegler-Natta processes or metallocene-catalyzed processes, may be used. For example, the rPP may be a commercially available polypropylene produced according to Borealis’ Ever Minds™ technology.

The recycled plastics, in particular the recycled PET and the recycled PP, in both the metallized and non-metallized versions, may be spun into the appropriate fibers, from which the corresponding staple fibers or meltblown or spunbond non-wovens may be produced for the purposes of the present invention. In particular, the use of chemically recycled rPP has the advantage that it may be processed into meltblown or spunbond non-wovens having excellent properties. In this context, for example, it is very advantageous that meltblown or spunbond non-wovens made from this rPP material may be electrostatically charged particularly favorably. After corona treatment, an rPP material obtained in this way exhibits excellent adhesion to all other layers/materials of the present invention. This may be explained in particular by the fact that the chargeability and charge persistence of such an rPP-based material are good and comparable to the properties of a material made from “virgin” PP.

Furthermore, in particular, the bi-component fibers described above may also have a sheath made of chemically recycled polypropylene.

The layer of non-woven including or consisting of fibers formed from one or more recycled plastics may be electrostatically charged. The electrostatic charging of the non-woven layer may be accomplished by corona charging or hydrocharging. In particular, fibers formed from the chemically recycled rPP material described above, i.e., melt spun, thus allow for an ecologically advantageous embodiment with excellent filtration properties.

Preferably, the air permeable material has a multi-layered structure, wherein at least one, more or all of the layers include or are formed from a non-woven and/or a fiber web, wherein the non-woven or fiber web includes or is formed from fibers formed from one or more recycled plastics.

Overall, the structure of the wall of the filter bag according to the present invention may be configured as described in EP 1 795 247. Such a wall thus includes at least three layers, at least two layers including at least one non-woven layer and at least one fiber web layer including staple fibers and/or filaments. Accordingly, the wall of the vacuum cleaner filter bag is additionally characterized by a welded joint, in which all layers of the filter material are joined together by welded joints. The pressed surface portion of the weld pattern amounts to a maximum of 5% of the surface area of the flowable surface of the filter material or vacuum cleaner filter bag. In relation to the total flow-through area of the filter bag, there are on average a maximum of 19 welded joints per 10 cm².

For example, the air-permeable material may be configured in a manner as described in the introductory part of the present patent application, i.e., for example, as described in EP 1 198 280, EP 2 433 695, EP 1 254 693, DE 199 19 809, EP 1 795 247, WO 2013/106 392 or CN 101747596, as long as a recycled plastic material has been used for the production of these filter materials. With respect to the detailed structure of these filter materials, reference is made to the disclosure of these documents, which in this respect are also to be included in the disclosure of the present invention.

The present invention covers several particularly preferred options of forming the air-permeable material in multiple layers, which are presented below. The plurality of these layers may be joined together by means of welded joints, in particular as described in EP 1 795 427 A1. The layers may also be glued together or bonded as described in WO 01/003802.

In particular, the invention provides a vacuum cleaner filter bag having a wall of air-permeable material, wherein the material includes a capacity layer and a fine filter layer,
wherein the capacity layer is a non-woven of staple fibers produced by an aerodynamic process, the staple fibers being formed from one or more recycled plastics, and
wherein the fine filter layer is a meltblown non-woven made of virgin PP or rPP, which is in particular electrostatically charged, or is a meltblown non-woven made of bi-component fibers with an rPET or an rPP core and a sheath made of virgin PP, rPP or virgin PMP, or is a support layer made of recycled plastic fibers with a layer of nanofibers applied thereon.

Thus, the capacity layer may correspond to the layer of non-woven or fiber web already described above.

In particular, the staple fibers of the capacity layer may include or consist of rPET or rPP. The term “nanofiber” is used according to the terminology of DIN SPEC 1121:2010-02 (CEN ISO/TS 27687:2009).

The fine filter layer may be located downstream of the capacity layer in the air flow direction (from the dirty air side toward the clean air side).

Optionally, the vacuum cleaner filter bag may have an (additional) reinforcing layer or support layer in the form of a dry-laid non-woven layer or in the form of an extrusion non-woven layer. As described above, the dry-laid non-woven layer may include dusty or dust-like and/or fibrous or fiber-like recycled material from the manufacture of textiles, in particular cotton textiles, and/or from wool shearing and/or seed fibers; alternatively, the dry-laid non-woven layer may include staple fibers of recycled plastic, in particular rPET or rPP. The extrusion non-woven layer may include mono- or bi-component filaments of recycled plastic, in particular rPET or rPP.

The reinforcing layer may be located downstream of the fine filter layer in the air flow direction.

According to one embodiment, the air-permeable material includes at least one support layer and at least one fine filter layer, wherein at least one or all of the support layers and/or at least one or all of the fine filter layers are non-wovens formed from one or more recycled plastics.

According to an alternative embodiment, the air-permeable material includes at least one support layer and at least one capacity layer, wherein at least one or all of the support layers are non-wovens and/or at least one or all of the capacity layers are non-wovens or fiber webs formed from one or more recycled plastics.

In another embodiment the air-permeable material includes at least one support layer, at least one fine filter layer, and at least one capacity layer, wherein at least one or all of the support layers and/or at least one or all of the fine filter layers are non-wovens formed from one or more recycled plastics and/or at least one or all of the capacity layers are non-wovens or fiber webs formed from one or more recycled plastics.

In the above embodiments, it is equally possible that at least one, preferably all, of the capacity layers include or are formed from a non-woven including dusty and/or fibrous recycled material and/or seed fibers. As a result of the non-woven bonding that has taken place, the non-woven layer formed as the capacity layer has such a high mechanical strength that it may also function as a support layer.

It is also possible to form the outer layer on the clean air side from a relatively thin material based on cotton dust.

The individual layers are described in more detail according to their function.

A supporting layer (sometimes also called “reinforcing layer”) in the sense of the present invention is a layer that gives the necessary mechanical strength to the multilayer composite of the filter material. This refers to an open, porous non-woven or a non-woven with a light basis weight. A support layer serves, among other things, to support other layers or sheets and/or to protect them from abrasion. The support layer may also filter the largest particles. The support layer, as well as any other layer of the filter material, may also be electrostatically charged, if necessary, provided that the material has suitable dielectric properties.

A capacity layer provides high resistance to shock loading, filtering large dirt particles, filtering a significant proportion of small dust particles, storing or retaining large quantities of particles, while allowing the air to pass through easily, resulting in a low pressure drop at high particle loading. This has a particular effect on the service life of a vacuum cleaner filter bag.

A fine filter layer serves to increase the filtration performance of the multilayer filter material by trapping particles that pass through the support layer and/or the capacity layer, for example. To further increase the separation efficiency, the fine filter layer may preferably be electrostatically charged (e.g., by corona discharge or hydrocharging), in particular to increase the separation of fine dust particles.

An overview of the individual functional layers within multilayer filter materials for vacuum cleaner filter bags is provided in WO 01/003802. The air-permeable material of the wall of the vacuum cleaner filter bag according to the invention may be constructed with respect to its configuration, for example, as in this patent document, with the proviso that at least one of the layers of the multilayer filter material for the vacuum cleaner filter bag described therein is formed from a recycled plastic or several recycled plastics. The disclosure of WO 01/003802 is likewise included in the present application with respect to the structure of the air-permeable filter materials.

In the aforementioned embodiments, it is advantageous that each support layer is a spunbond or scrim, preferably having a grammage from 5 to 80 g/m², more preferably from 10 to 50 g/m², more preferably from 15 to 30 g/m², and/or preferably having a titer of the fibers forming the spunbond or scrim in the range of from 0.5 dtex to 15 dtex.

Preferably, the air-permeable material may include one to three support layers.

In the case of the presence of at least two support layers, the total grammage of the sum of all support layers is preferably 10 to 240 g/m², more preferably 15 to 150 g/m², more preferably 20 to 100 g/m², more preferably 30 to 90 g/m², in particular 40 to 70 g/m².

In particular, it is preferred that all the support layers are formed from a recycled plastic or several recycled plastics, in particular from rPET or rPP.

According to a further advantageous embodiment, each fine filter layer is an extrusion non-woven, in particular a meltblown non-woven, preferably with a grammage of 5 to 100 g/m², further preferably 10 to 50 g/m², in particular 10 to 30 g/m².

Here, it is possible for the air-permeable material to include 1 to 5 fine filter layers.

In the case of the presence of at least two fine filter layers, the total grammage of the sum of all fine filter layers is preferably 10 to 300 g/m², more preferably 15 to 150 g/m², in particular 20 to 50 g/m².

In particular, it is preferred that at least one, preferably all, fine filter layers are formed from a recycled plastic or several recycled plastics, in particular from rPET or rPP.

To increase the dust collection performance, in particular with regard to fine dusts, it is particularly preferred if at least one, preferably all, fine filter layers are electrostatically charged.

It is further advantageous if each capacity layer is a staple fiber non-woven, a fiber web or a non-woven including dusty or dust-like and/or fibrous or fiber-like recycled material from the manufacture of textiles, in particular cotton textiles, and/or from wool shearing and/or seed fibers, each capacity layer preferably having a grammage of from 5 to 200 g/m², more preferably from 10 to 150 g/m², more preferably from 20 to 100 g/m², in particular from 30 to 50 g/m².

Here, it may convenient that the air-permeable material includes 1 to 5 capacity layers.

In the case of the presence of at least two capacity layers, the total grammage of the sum of all capacity layers is preferably from 10 to 300 g/m², more preferably from 15 to 200 g/m², more preferably from 20 to 100 g/m², in particular from 50 to 90 g/m².

A particularly preferred embodiment of the structure of the air-permeable material for the vacuum cleaner filter bag according to the invention provides for the multilayer structure described below with a sequence of layers extending from the interior of the vacuum cleaner filter bag (dirty air side) to the outside (clean air side):

a support layer, at least one, preferably at least two fine filter layers, and a further support layer.

In particular, in the case where the support layer is constructed as a spunbond non-woven and the fine filter layer as a meltblown non-woven, this structure corresponds to the SMS or SMMS structure for air-permeable filter materials for vacuum cleaner filter bags known from the prior art.

Alternatively and in particular, the following structure is preferred:

A support layer, at least one, preferably at least two, capacity layers, preferably a further support layer, at least one, preferably at least two, fine filter layers, and a further support layer. In the case that the capacity layer has a high mechanical strength as described above, the innermost support layer may also be dispensed with.

One or two capacity layers, one or two fine filter layers (meltblown layers), one support layer (spunbonded fabric).

One or two capacity layers, one or two fine filter layers (meltblown layers), one or two capacity layers.

At least one of the layers includes at least one recycled plastic material, in particular rPET or rPP. Particularly preferably, at least all of the support layers are formed from recycled plastics.

Each of the aforementioned layers (support layer, capacity layer, fine filter layer) may thereby also be formed from a non-woven material including dusty and/or fibrous recycled material from the production of textiles, in particular cotton textiles, and/or from wool shearing and/or seed fibers.

In a particularly preferred embodiment, this non-woven material forms the at least one capacity layer, while the other layers do not include dusty and/or fibrous recycled material from the manufacture of textiles, in particular cotton textiles and/or seed fibers.

It is also possible for all of the layers in the aforementioned embodiments to be joined together by means of welded joints, in particular as described in EP 1 795 427 A1. However, welded joints are not absolutely necessary.

According to a further preferred embodiment, the vacuum cleaner filter bag has a retaining plate that encloses the inlet opening and is formed from one or more recycled plastics or includes one or more recycled plastics. In particular, the retaining plate is thereby formed of rPET or rPP or includes rPET or rPP in a very high proportion, for example at least 90% by weight. According to this preferred embodiment, it is thus possible to further increase the proportion of recycled plastics in the vacuum cleaner filter bag.

Furthermore, it is possible that at least one flow distributor and/or at least one diffuser are arranged in the interior, wherein preferably the at least one flow distributor and/or the at least one diffuser is formed from one recycled plastic or several recycled plastics. Such flow distributors and/or diffusers are known, for example, from patent applications EP 2 263 508, EP 2 442 703, DE 20 2006 020 047, DE 20 2008 003 248, DE 20 2008 005 050. The vacuum cleaner filter bags according to the invention, including flow distributors, may also be designed accordingly.

Flow distributors and diffusers are preferably also made of non-wovens or laminates of non-wovens. Preferably, the same materials are considered for these elements as for the capacity and reinforcement layers.

In a further particularly preferred embodiment the proportion by weight of all recycled materials, based on the total weight of the vacuum cleaner filter bag, is at least 25%, preferably at least 30%, further preferably at least 40%, further preferably at least 50%, further preferably at least 60%, further preferably at least 70%, further preferably at least 80%, further preferably at least 90%, in particular at least 95%. Thus, the requirements of the Global Recycled Standard (GRS), v3 (August 2014) of Textile Exchange may be achieved.

The vacuum cleaner filter bag according to the present invention may, for example, be in the form of a flat bag, a side gusset bag, a block bottom bag or a 3D bag, such as a vacuum cleaner filter bag for an upright vacuum cleaner. In this case, a flat bag has no side walls and is formed from two layers of material, the two layers of material being directly joined to one another along their circumference, for example welded or glued. Side gusset bags represent a modified form of a flat bag and include fixed or expandable side gussets. Block bottom bags include a so-called block or block bottom, which mostly forms the narrow side of the vacuum cleaner filter bag; a retaining plate is usually arranged on this side.

In addition, the present invention relates to the use of recycled plastics, in particular the recycled plastics described above, for example in the form of non-wovens and/or fiber webs for vacuum cleaner filter bags. With regard to the recycled plastics that may be used for this purpose or the possible design of the non-wovens or fiber webs, reference is made in this respect to the preceding explanations.

The present invention will be elucidated in more detail with reference to the following exemplary embodiments, without limiting the invention to the specific embodiments shown.

Filter bags are designed that include one or more layers of rPET or rPP filaments or rPET or rPP staple fibers. In addition, the filter bags according to the invention described below may have one or more layers of an aerodynamically formed non-woven, for example an airlaid or an airlay non-woven formed from cotton dust, seed fibers or wool fibers from shearing waste and bi-component fibers. The different non-wovens are only suitable for certain material layers. In order to further increase the proportion of recycled raw materials, it is also possible to use a retaining plate that is made of rPET or rPP or at least has rPET or rPP.

Regarding the individual filter layers:

Spunbonded layers made of rPET or rPP with a basis weight of 5 to 50 g/m² and a titer of 1 dtex to 15 dtex are particularly suitable as support layers. For example, PET waste (e.g. punching waste) and so-called bottle flakes, i.e. pieces of ground beverage bottles, are used as raw materials. To cover the different coloration of the waste, it is possible to dye the recyclate. The HELIXⓇ (Comerio Ercole) process is particularly advantageous as a thermal bonding process for consolidating the spunbond.

One or more layers of meltblown from rPET or rPP with a basis weight of 5 to 30 g/m² each are used as fine filter layers. In addition, one or more meltblown non-woven layers of virgin PP may be present. At least this (these) layer(s) is (are) electrostatically charged by a corona discharge. The layers made of rPET or rPP may also be electrostatically charged. The only thing to keep in mind is that no metallized PET waste is then used for production. Alternatively, the meltblown filaments may also consist of bi-component fibers, in which the core is formed from rPET or rPP and the sheath from a plastic that efficiently allows to be electrostatically charged (e.g. virgin PP, PC, PET, or rPP).

One or more capacity layers include rPET or rPP staple fibers or rPET or rPP filaments, or are based on cotton dust (or seed fibers) and bi-component fibers. Different processes are suitable for the production of capacity layers. Carding processes, airlay processes or airlaid processes are commonly used, in which staple fibers are first laid down, which are then usually bonded in a non-woven bonding step (e.g. by needling, hydroentanglement, ultrasonic calendering, by means of thermal bonding in a flow-through oven also by means of bi-component fibers or bonding fibers, or by chemical bonding, for example with latex, hotmelt, foam binder, ...) to form a non-woven. For calendering, the HELIX@ (Comerio Ercole) process is particularly advantageous. In an airlay process, a Rando-Webber system may be used in particular.

Also used is a process, in which the primarily formed fiber web is not consolidated, but is bonded to a non-woven with as few weld points as possible. In both processes, it is possible to use staple fibers made from rPET or rPP. Capacity layers may also be manufactured as extrusion non-wovens or extrusion fiber webs. For these non-wovens, the use of rPET or rPP is also feasible without any problems.

The filaments or staple fibers may also be made from bi-component materials, in which the core is formed from rPET or rPP and the sheath from a plastic that is particularly well suited to electrostatic charging (e.g. virgin PP, PC, PET, or rPP).

Alternatively or supplementally, there may be one or more layers of an aerodynamically formed non-woven formed from bi-component fibers and cotton dust or seed fibers.

The basis weight of the individual capacity layers is preferably between 10 and 100 g/m².

The differently produced capacity layers may, of course, also be combined with each other.

To further increase the proportion of recyclates, a retaining plate made of rPET may be used. If the seal to the vacuum cleaner nozzle is provided by the bagging material, the retaining plate may be made exclusively of rPET or rPP. If the retaining plate has to take over the sealing function, a TPE seal may be molded or glued on.

If all options are utilized, a recyclate or waste material content of up to 96% may be achieved in this way. The following tables give some specific design examples with a recyclate content of 41 % to 96 %.

The vacuum cleaner filter bags shown below were designed from the various recyclate-containing non-wovens or fiber webs using the specified materials, whose exact composition or structure is shown in the following tables. The vacuum cleaner filter bags are flat bags with a rectangular geometry and dimensions of 300 mm × 280 mm.

TABLE 1

Example 1

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Supporting layer inside | 17 | 2.9 | 100 |
| Retaining plate | | 5.0 | 0 |
| Total filter bag | | 17.1 | 41.3 |

The air-permeable material of the vacuum cleaner filter bag according to Example 1 has a four-layer structure, the outermost layer (on the clean air side) having a supporting layer with a grammage of 25 g/m². The innermost layer is also a support layer with a grammage of 17 g/m². Two layers of a fine filter layer (meltblown virgin polypropylene, each electrostatically charged by corona discharge) with a grammage of 15 g/m² are arranged between the two support layers. The supporting layers are each made from 100% recycled PET. The third column indicates the absolute weight of each layer in the vacuum cleaner filter bag. The vacuum cleaner filter bag has a retaining plate that weighs 5.0 g and is welded to the vacuum cleaner filter bag.

With such a structure, a percentage of a recycled material in the entire vacuum cleaner filter bag of 41.3% may be achieved.

TABLE 2

Example 2

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Supporting layer inside | 17 | 2.9 | 100 |
| Retaining plate | | 5.0 | 100 |
| Total filter bag | | 17.1 | 70.5 |

The vacuum cleaner filter bag according to Example 2 is constructed identically to the vacuum cleaner filter bag according to Example 1, with the difference that the support plate is formed from 100% recycled polyethylene terephthalate (rPET). This measure allows the proportion of recyclate in the entire vacuum cleaner filter bag to be increased to 70.5%.

TABLE 3

Example 3

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 100 |
| Supporting layer inside | 17 | 2.9 | 100 |
| Retaining plate | | 5.0 | 100 |
| Total filter bag | | 17.1 | 85.3 |

The vacuum cleaner filter bag according to Example 3 has an identical structure to Example 2. In contrast to the embodiment according to Example 2 or Example 1, a fine filter layer (inner meltblown layer) is now also formed from 100% recycled PET. The rPET used may be metallized or unmetallized. In the case that unmetallized rPET is used, it is also possible to charge this meltblown electrostatically, for example by means of corona discharge.

TABLE 4

Example 4

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 85 |
| Meltblown | 15 | 2.5 | 85 |
| Supporting layer inside | 17 | 2.9 | 100 |
| Retaining plate | | 5.0 | 100 |
| Total filter bag | | 17.1 | 95.6 |

The vacuum cleaner filter bag according to Example 4 has an identical structure to the vacuum cleaner filter bag according to Example 2, except for the fact that the two fine filter layers (meltblown) are formed from BiKo filaments. The core of these meltblown filaments is made of recycled PET, the cover of virgin polypropylene. The core accounts for 85% of the weight.

With such measures, a recyclate content of 95.6% by weight, based on the entire vacuum cleaner filter bag, is achieved.

TABLE 5

Example 5

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer A | 35 | 5.9 | 50 |
| Capacity layer B | 35 | 5.9 | 50 |
| Supporting layer inside | 15 | 2.5 | 100 |
| Retaining plate | | 5.0 | 0 |
| Total filter bag | | 31.4 | 49.3 |

The wall material of the vacuum cleaner filter bag according to Example 5 has a 7-layer structure. An outer support layer arranged on the clean air side is followed by two fine filter layers (in each case meltblown layers, as in Example 1). A centrally arranged support layer separates these fine filter layers from two capacity layers A and B, each of which is a carded non-woven made of bi-component staple fibers. These staple fibers consist of, for example, 50% recycled polyethylene terephthalate (rPET), which forms the core of these fibers. The core is surrounded by a sheath of “virgin” PP. This is followed by a support layer arranged on the dirty air side.

In the structure according to Example 5, all support layers of the air-permeable material are formed from recycled PET (rPET). The capacity layers are formed from 50% recycled PET. With such a construction, a recyclate content of 49.3% by weight, based on the total vacuum cleaner filter bag, is achieved.

TABLE 6

Example 6

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer A | 35 | 5.9 | 100 |
| Capacity layer B | 35 | 5.9 | 100 |
| Supporting layer inside | 15 | 2.5 | 100 |
| Retaining plate | | 5.0 | 0 |
| Total filter bag | | 31.4 | 68.0 |

The vacuum cleaner filter bag according to Example 6 has an identical structure to Example 5. In contrast to the embodiment according to Example 5, the capacity layers A and B are now also formed 100% from a carded staple fiber non-woven made of rPET staple fibers.

With such an embodiment, a recyclate content of 68.0% by weight, based on the entire vacuum cleaner filter bag, is achieved.

TABLE 7

Example 7

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer A | 35 | 5.9 | 50 |
| Capacity layer B | 35 | 5.9 | 50 |
| Supporting layer inside | 15 | 2.5 | 100 |
| Retaining plate | | 5.0 | 100 |
| Total filter bag | | 31.4 | 83.9 |

In the vacuum cleaner filter bag according to Example 7, the retaining plate is now also made of 100% recycled PET. In all other respects, the vacuum cleaner filter bag has an identical structure to Example 6.

With such a structure, a total recyclate content, based on the entire vacuum cleaner filter bag, of 83.9% by weight is achieved.

TABLE 8

Example 8

| Volumetric non-woven 70 300 mm × 280 mm | Grammage [g/m²] | Weight per bag [g] | Percentage Recyclate [%] |
|---|---|---|---|
| Supporting layers outside | 25 | 4.2 | 100 |
| Meltblown | 15 | 2.5 | 80 |
| Meltblown | 15 | 2.5 | 80 |
| Center support layer | 17 | 2.9 | 100 |
| Capacity layer A | 35 | 5.9 | 100 |
| Capacity layer B | 35 | 5.9 | 100 |
| Supporting layer inside | 15 | 2.5 | 100 |
| Retaining plate | | 5.0 | 100 |
| Total filter bag | | 31.4 | 96.8 |

The vacuum cleaner filter bag according to Example 8 has an identical structure to that of Example 7, except for the fact that the two fine filter layers (meltblown layers) are also formed to a high degree from recycled PET. The meltblown is formed from a bi-component meltblown with a core of rPET, coated with virgin polypropylene. The proportion of rPET here is 80% by weight, based on the total mass of the meltblown that forms the respective fine filter layer.

With such a structure, a total content of recycled materials, based on the entire filter bag of 96.8 wt.% may be achieved.

TABLE 9

Example 9

| | Grammage [g/m²] | Weight per bag [g] | r Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer C | 35 | 5.9 | 80 |
| Capacity layer D | 35 | 5.9 | 80 |
| Supporting layer inside | 15 | 2.5 | 100 |
| Retaining plate | | 5.0 | 0 |
| Total filter bag | | 31.4 | 60.5 |

The vacuum cleaner filter bag according to Example 9 is also made of a 7-layer air-permeable material. The vacuum cleaner filter bag has a similar structure to the vacuum cleaner filter bag according to Example 5. The support layers and the fine filter layers (meltblown layers) are identical to those in Example 5. In this case, the capacity layers C and D are formed from a non-woven material that is formed from 80% by weight of cotton dust or seed fibers and 20% of BiCo bonding fiber. This non-woven material is described in detail in WO 2011/057641 A1. The proportion of cotton dust or seed fibers in the capacity layers is thereby added to the total proportion of recyclate.

With such an embodiment, a proportion of recycled material, i.e. the sum of recycled plastics, and cotton dust or seed fibers of 60.5% by weight, based on the total vacuum cleaner filter bag, is achieved.

TABLE 10

Example 10

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer A | 35 | 5.9 | 100 |
| Capacity layer D | 35 | 5.9 | 80 |
| Supporting layer inside | 15 | 2.5 | 100 |
| Retaining plate | | 5.0 | 100 |
| Total filter bag | | 31.4 | 64.3 |

The vacuum cleaner filter bag according to Example 10 is constructed analogously to the vacuum cleaner filter bag according to Example 9. Here, the outer capacity layer corresponds to a capacity layer according to Examples 6 to 8, i.e. a carded staple fiber non-woven formed from 100% recycled PET fibers. The recyclate content of a finished vacuum cleaner filter bag corresponds to 64.3% by weight.

TABLE 11

Example 11

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 0 |
| Meltblown | 15 | 2.5 | 0 |
| Center support layer | 17 | 2.9 | 100 |
| Capacity layer C | 35 | 5.9 | 80 |
| Capacity layer D | 35 | 5.9 | 80 |
| Supporting layer inside | 15 | 2.5 | 100 |
| Retaining plate | | 5.0 | 100 |
| Total filter bag | | 31.4 | 76.4 |

The vacuum cleaner filter bag according to Example 11 corresponds to a vacuum cleaner filter bag according to Example 9, with the difference that the retaining plate is formed from 100% rPET. The total percentage of recycled materials in this vacuum cleaner filter bag is 76.4 wt%.

TABLE 12

Example 12

| | Grammage [g/m²] | Weight per bag [g] | Percentage Recyclate [%] |
|---|---|---|---|
| Supporting layers outside | 25 | 4.2 | 100 |
| Meltblown | 15 | 2.5 | 80 |
| Meltblown | 15 | 2.5 | 80 |
| Center support layer | 17 | 2.9 | 100 |
| Capacity layer C | 35 | 5.9 | 80 |
| Capacity layer D | 35 | 5.9 | 80 |
| Supporting layer inside | 15 | 2.5 | 100 |
| Retaining plate | | 5.0 | 100 |
| Total filter bag | | 31.4 | 89.3 |

The vacuum cleaner filter bag according to Example 12 corresponds to the vacuum cleaner filter bag according to Example 11, with the difference that the two fine filter layers are designed according to the fine filter layers according to Example 8 and are thus formed from a bi-component meltblown with a core of rPET and a sheath of polypropylene. The total recyclate content of such a vacuum cleaner filter bag is 89.3% by weight.

1. A vacuum cleaner filter bag comprising:
a wall made of an air-permeable material surrounding an inner space; and
an inlet opening introduced into the wall, wherein the air-permeable material comprises at least one of a layer of a non-woven or a layer of a fiber web comprising fibers formed from one or more recycled plastics, and wherein the one or more recycled plastics comprise chemically recycled polypropylene.

2. The vacuum cleaner filter bag according to claim 1, wherein the one or more recycled plastics is electrostatically charged.

3. The vacuum cleaner filter bag according to claim 1, wherein the air-permeable material is a multi-layer structure, wherein at least two layers of the multi-layer structure comprise or are formed from at least one of a non-woven or a fiber web, wherein the non-woven or the fiber web includes fibers formed from one or more recycled plastics.

4. The vacuum cleaner filter bag according to claim 1, wherein the air-permeable material comprises a capacity layer and a fine filter layer, wherein the capacity layer is a non-woven formed from staple fibers produced by an aerodynamic process, the staple fibers being formed from one or more recycled plastics, and wherein the fine filter layer is a meltblown non-woven made of electrostatically charged virgin PP, or is a meltblown non-woven made of bicomponent fibers with a recycled polyethylene terephthalate (rPET) or a recycled polypropylene (rPP) core and a sheath made of virgin polypropylene (PP) or virgin polymethylpentene (PMP), or is a support layer made of recycled plastic fibers with a layer of nano-fibers applied thereto.

5. The vacuum cleaner filter bag according to claim 1, wherein the air-permeable material comprises:
at least one support layer and at least one fine filter layer, wherein one or more of the at least one support layer and/or one or more of the at least one fine filter layer includes one or more non-wovens formed from one or more recycled plastics;
at least one support layer and at least one capacity layer, wherein one or more layers of the at least one support layer are non-wovens and/or one or more layers of the at least one capacity layer include at least one of non-wovens or fiber webs formed from one or more recycled plastics; or
at least one support layer, at least one fine filter layer, and at least one capacity layer, wherein one or more layers of the at least one support layer, and/or one or more layers of the at least one fine filter layer include non-wovens formed from one or more recycled plastics and/or one or more layers of the at least one capacity layer include non-wovens or fiber webs formed from one or more recycled plastics.

6. The vacuum cleaner filter bag according to claim 5, wherein at least one of:
each support layer is a spunbond or scrim, having a grammage of from 5 to 80 g/m², and/or having a titer of the fibers forming the spunbond or scrim in a range of from 0.5 dtex to 15 dtex;
the air-permeable material comprises 1 to 3 support layers, wherein when the air-permeable material comprises at least two support layers, a total grammage of a sum of all support layers is 10 to 240 g/m²; or
all support layers are formed from a recycled plastic or a plurality of recycled plastics .

7. The vacuum cleaner filter bag according to claim 5, wherein at least one of:
each fine filter layer includes an extrusion non-woven, with a grammage of 5 to 100 g/m²;
the air-permeable material comprises 1 to 5 fine filter layers, wherein when the air-permeable material comprises at least two fine filter layers, a total grammage of a sum of all fine filter layers is 10 to 300 g/m²;
at least one of the fine filter layers is formed from one recycled plastic or a plurality of recycled plastics; or
at least one of the fine filter layers are electrostatically charged.

8. The vacuum cleaner filter bag according to claim 5, wherein at least one of:
each capacity layer includes at least one of a staple fiber non-woven, a fiber web, or a non-woven comprising dusty and/or fibrous recycled material from production of textiles, wherein each capacity layer has a grammage from 5 to 200 g/m²; or
the air-permeable material comprises 1 to 5 capacity layers, wherein when the air-permeable material comprises at least two capacity layers, a total grammage of a sum of all capacity layers is 10 to 300 g/m² .

9. The vacuum cleaner filter bag according to claim 1, wherein the air-permeable material is a multi-layer structure with a layer sequence as seen from an interior of the vacuum cleaner filter bag, the vacuum cleaner filter bag further comprising:
a support layer, at least one fine filter layer, and a second support layer; or
a support layer, at least one capacity layer, a second support layer, at least one fine filter layer, and a third support layer.

10. The vacuum cleaner filter bag according to claim 1, wherein the vacuum cleaner filter bag comprises:
a retaining plate enclosing the inlet opening, the retaining plate being formed from or comprising one or more recycled plastics.

11. The vacuum cleaner filter bag according to claim 1, wherein at least one of: at least one flow distributor or at least one diffuser is arranged in an interior of the vacuum cleaner filter bag, wherein the at least one flow distributor and/or the at least one diffuser is formed from one or more recycled plastics.

12. The vacuum cleaner filter bag according to claim 1, wherein a proportion by weight of all recycled materials, relative to a total weight of the vacuum cleaner filter bag is at least 25%.

13. The vacuum cleaner filter bag according to claim 1, wherein the vacuum cleaner filter bag is a flat bag, a block bottom bag, or a 3D bag.

14. (canceled)

15. A vacuum cleaner filter bag comprising:
a wall formed from an air-permeable material surrounding an inner space;
an inlet opening formed in the wall;
a retaining plate enclosing the inlet opening; and
at least one of at least one flow distributor or at least one diffuser arranged in an interior of the vacuum cleaner filter bag;
wherein the air-permeable material includes at least one of a layer of non-woven or a layer of a fiber web comprising fibers formed from chemically recycled polypropylene.

16. The vacuum cleaner filter bag of claim 15, wherein the chemically recycled polypropylene is electrostatically charged.

17. The vacuum cleaner filter bag of claim 15, wherein the retaining plate and at least one of the at least one flow distributor or the at least one diffuser are formed from or comprise one or more recycled plastics.

18. The vacuum cleaner filter bag of claim 15, wherein a proportion by weight of all recycled materials relative to a total weight of the vacuum cleaner filter bag is at least 95%.

19. A vacuum cleaner filter bag comprising:
a wall formed from an air-permeable material surrounding an inner space; and
an inlet opening formed in the wall;
wherein the air-permeable material is a multi-layer structure, wherein at least one layer of the multi-layer structure comprises a non-woven or a fiber web comprising fibers formed from one or more recycled plastics, and wherein the air-permeable material comprises a capacity layer and a fine filter layer.

20. The vacuum cleaner filter bag of claim 19, wherein the capacity layer includes a non-woven formed from one or more staple fibers produced by an aerodynamic process, the one or more staple fibers being formed from one or more recycled plastics, and wherein the fine filter layer is a melt-blown non-woven made of electrostatically charged virgin polypropylene (PP) or is a melt-blown non-woven made of bi-component fibers with a recycled polyethylene terephthalate (rPET) or a recycled polypropylene (rPP) core, and a sheath made of virgin polypropylene (PP) or virgin polymethylpentene (PMP), or is a support layer made of recycled plastic fibers with a layer of nano-fibers applied thereto.

21. The vacuum cleaner filter bag of claim 19, wherein the capacity layer includes at least one of a staple fiber non-woven, a fiber web, or a non-woven comprising dusty and/or fibrous recycled material from production of textiles, wherein the capacity layer has a grammage from 5 to 200 g/m².
